(19) United States
(12) Patent Application Publication
(10) Pub. No.: US 2016/0379386 A1
(43) Pub. Date: Dec. 29, 2016

(54) USER ORIENTATION WHEN WORKING WITH SPATIAL DATA ON A MAPPING INTERFACE

(71) Applicant: SAP SE, Walldorf (DE)

(72) Inventors: Sebastian Doeweling, Griesheim (DE); Tarik Tahiri, Limburg a.d. Lahn (DE)

(21) Appl. No.: 14/748,603

(22) Filed: Jun. 24, 2015

(51) Int. Cl. G06T 11/20; G01C 17/00; G06T 11/60; G06T 3/40; G06F 3/0484; G06F 17/24

(52) U.S. Cl. CPC G06T 11/206; G06F 3/04842; G06F 17/245; G06T 11/60; G06T 3/40; G06F 3/04845; G01C 17/00

(57) ABSTRACT

The present disclosure describes methods and systems, including computer-implemented methods, computer program products, and computer systems, for improving user orientation when working with spatial data on a mapping interface. One design-time computer-implemented method comprises calculating a set of screen coordinates on a mapping user interface for a compass user interface element, the compass user interface element associated with a layer selected to add to the mapping user interface; calculating map coordinates equivalent to the set of screen coordinates for the compass user interface element; determining on- and off-screen data elements associated with the added layer; calculating direction and distance to a closest number of data elements from the map coordinates of the compass user interface element; and rendering the compass user interface element on the mapping user interface.

### BACKGROUND

A geographic information system (GIS) can be used to manage and present geographical data. Geographic data can be presented in a GIS using one or more layers. A layer is a visual representation of a geographic dataset that is presented in a mapping user interface. For example, multiple, separate layers of roads, rivers, and political boundaries can be displayed on the mapping user interface. A mapping application may allow the user to add or remove layers, which can allow the user to see more or less information on the mapping user interface.

### SUMMARY

The present disclosure relates to computer-implemented methods, computer-readable media, and computer systems for improving user orientation when working with spatial data on a mapping interface. One design-time computer-implemented method includes calculating a set of screen coordinates on a mapping user interface for a compass user interface element, the compass user interface element associated with a layer selected to add to the mapping user interface; calculating map coordinates equivalent to the set of screen coordinates for the compass user interface element; determining on- and off-screen data elements associated with the added layer; calculating direction and distance to a closest number of data elements from the map coordinates of the compass user interface element; and rendering the compass user interface element on the mapping user interface.

Other implementations can include corresponding computer systems, apparatuses, and computer programs recorded on one or more computer storage devices, each configured to perform the actions of the methods. A system of one or more computers can be configured to perform particular operations or actions by virtue of having software, firmware, hardware, or a combination of software, firmware, or hardware installed on the system that in operation causes or causes the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination:

A first aspect, combinable with the general implementation, wherein the determination is made based on the smallest and largest X and Y coordinates of a visible segment of the mapping user interface.

A second aspect, combinable with the general implementation, wherein the calculation of direction and distance to the closest number of data elements is performed in the same processing loop where the on- and off-screen data elements are determined.

A third aspect, combinable with the general implementation, comprising displaying data pointers for on-screen data elements.

A fourth aspect, combinable with the general implementation, comprising calculating a zooming boundary associated with the mapping user interface.

A fifth aspect, combinable with the general implementation, comprising retrieving meta-data associated with the selected layer and retrieving additional related data associated with the selected layer for display on the mapping user interface.

A sixth aspect, combinable with the general implementation, comprising rendering a table with embedded compass widgets if the closet number of data elements exceeds one.

The subject matter described in this specification can be implemented in particular implementations so as to realize one or more of the following advantages. First, user orientation towards layer elements can be improved when working with spatial data on a mapping interface. Second, a compass user interface element can provide directional and distance information for elements of a selected layer. Third, the compass user interface element can provide direct navigation on the mapping interface to elements of the selected layer.

The details of one or more implementations of the subject matter of this specification are set forth in the accompanying drawings and the description below. Other features, aspects, and advantages of the subject matter will become apparent from the description, the drawings, and the claims.

### DESCRIPTION OF DRAWINGS

FIG. 1 is a high-level architecture block diagram illustrating an example distributed computing system (EDCS) for improving user orientation when working with spatial data on a mapping interface, according to an implementation.

FIG. 2 illustrates an example prior art mapping user interface, according to an implementation.

FIG. 3 illustrates an example compass user interface element according to an implementation.

FIG. 4 illustrates an example compass user interface element displayed on an example map segment, according to an implementation.

FIGS. 5A and 5B are flow charts of an example method for improving user orientation when working with spatial data on a mapping interface, according to an implementation.

FIG. 6 illustrates an example table with embedded compass user interface elements, according to an implementation.

FIG. 7 is a block diagram of an exemplary computer used in the EDCS, according to an implementation.

Like reference numbers and designations in the various drawings indicate like elements.

### DETAILED DESCRIPTION

The following detailed description is presented to enable any person skilled in the art to make, use, and/or practice the disclosed subject matter, and is provided in the context of one or more particular implementations. Various modifications to the disclosed implementations will be readily apparent to those skilled in the art, and the general principles defined herein may be applied to other implementations and applications without departing from scope of the disclosure. Thus, the present disclosure is not intended to be limited to the described and/or illustrated implementations, but is to be accorded the widest scope consistent with the principles and features disclosed herein.

When geographic information system (GIS) users work with complex spatial data, newly added elements on the map will often appear outside of the currently displayed map segment. Accordingly, they are unaware of the exact location of that data, and must change the currently displayed map segment, abandon their current task, or carry out a series of calculations to determine distance and location of that data. These actions typically mean that the user has to execute a number of distance tasks, whose results are then presented in form of a table instead of a more intuitive map display; directional information is usually not directly available, and the user must then navigate to the closest element either manually or using a locate/find task, when he/she wants to receive additional information about the respective object (e.g., the status of a transportation vehicle, distance to a hospital, estimated time of arrival of emergency responders, and the like). This is especially detrimental, when users—potentially collaboratively—carry out planning tasks, in which they regularly need to assess the distance and direction of the closest available resource.

A compass user interface element can be used to simplify presentation of spatial data orientation to users of a GIS system. The compass user interface element can provide directional and distance information for one or more elements of a selected layer, for example. The user can use the compass user interface element to adjust a current map segment to show either the closest element or all elements within the layer.

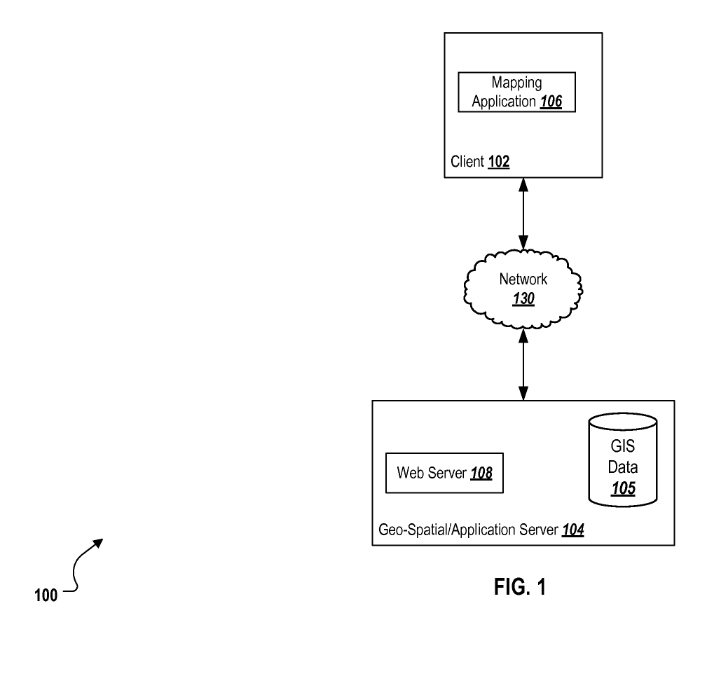

FIG. 1 is a high-level architecture block diagram illustrating an example distributed computing system (EDCS) 100 for providing for improving user orientation when working with spatial data on a mapping interface, according to an implementation. At a high level, the illustrated EDCS 100 includes or is made up of one or more communicably coupled computers that communicate across a network 130. In some implementations, the EDCS can wholly or partially be implemented to operate within or as a part of a cloud-computing-based environment. Although there is only one indicated instance of the network 130, one or more other illustrated connections between components of the EDCS 100 can also be considered part of the network 130. The illustrated EDCS 100 is typically a client/server-type environment and includes a client 102 (e.g., a web browser/native application on a mobile computing device, etc.) and a server 104 communicating over the network 130.

The server 104 can manage and provide access to geographical information stored in a GIS database 105. In some implementations, the server 104 includes a third party GIS server. In some implementations, a mapping application 106 included in the client 102 is a web-based application and the server 104 includes a web server 108 that is configured to receive and respond to requests from the mapping application 106. The server 104 can perform geographical calculations on behalf of the mapping application 106, for example.

The mapping application 106 can be used on the client 102 by a single user. As another example, the client 102 may be simultaneously used by multiple users. The client 102 may be a collaborative device, for example, such as a device used for disaster management. For example, the client 102 can be a digital touch table.

The mapping application 106 can be used to display geographic information on a mapping user interface. Different types of geographical information can be displayed in the mapping user interface using different layers. A user of the mapping application 106 may be associated with one or more roles. A role for a user may enable the user to select and interact with one or more layers that are associated with the role. For example, a user may add a layer to the mapping application 106, as part of collaborative planning.

A user of the mapping application 106 may desire, after adding a layer to the mapping application 106, to visualize direction and distance of elements that are included in the layer. For example, a layer may represent the locations of resources of a particular type (e.g., hospitals, fire trucks, ambulances, and the like). The user may desire to quickly determine the direction and distance to a closest resource of a particular type, for example, to dispatch the resource. As described in more detail below, a compass user interface element can be used to provide such functionality. In some implementations, a compass user interface element is displayed in the mapping application 106 for each of multiple selected layers. In other implementations, a single compass user interface element can be displayed in the mapping application 106 at a given time.

Although a single client 102 is displayed, multiple client devices 102 can interact with the server 104. In some implementations, the mapping application 106 can interface with a local server that is installed on the client 102. The GIS database 108 can also be located on the client 102 as a local database, and the local server can provide access to the local database to the mapping application 106.

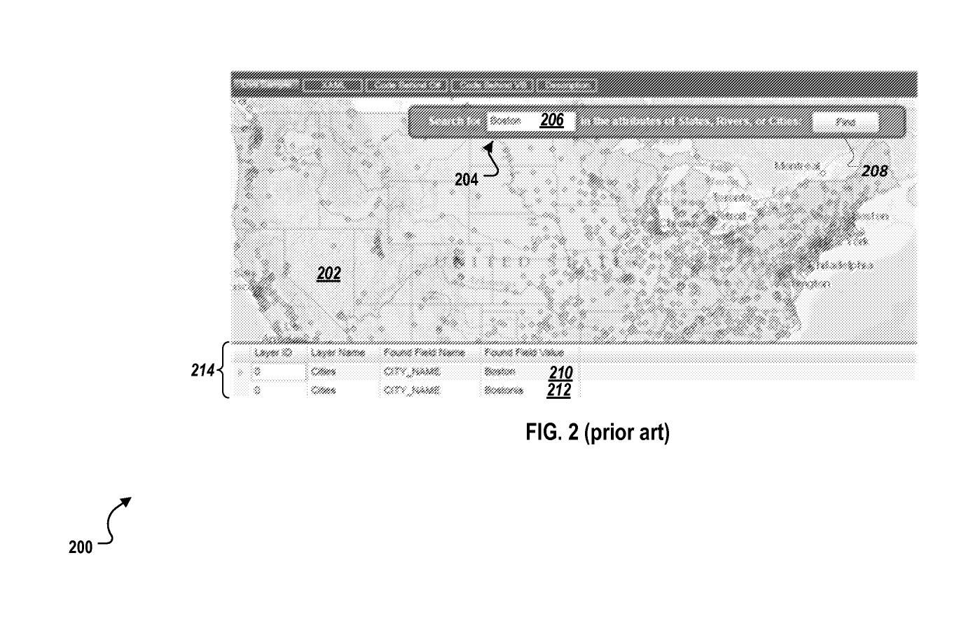

FIG. 2 illustrates an example prior art mapping user interface 200, according to an implementation. The mapping user interface 200 includes a map segment 202 which currently displays geographic information in three layers—a layer each for states, rivers, and cities. The mapping user interface 200 includes a search control 204 which allows the user to search for geographic elements that are associated with one of the displayed layers. For example, the user has entered a search of “Boston” into a search field 206. The user can submit the search using a user interface control 208. Search results 210 and 212 for the search are displayed in a search results table 214.

The search results 210 and 212 do not indicate the location of the corresponding elements, and do not indicate whether the corresponding elements are currently displayed in the map segment 202. The user may be able to carry out a series of calculations to determine distance and location for the elements corresponding to the search results 210 and 212, but results of such calculations may also be displayed in a table structure. To locate an element, the user may need to manually change the displayed map segment or manually perform some other find operation, which may disrupt the workflow of the user.

In contrast, the compass user interface element described herein can be embedded within the currently displayed map segment 202 and can present relevant distance and directional information at a location on the map segment 202 that is likely to be useful (e.g., a location at which a last user interaction occurred). The compass user interface element provides concise information related to the distance and direction of the closest elements of a desired element type, without disrupting the workflow of the user.

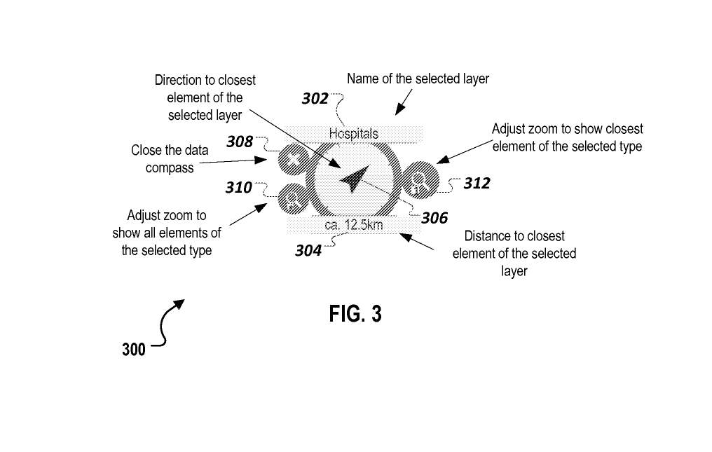

FIG. 3 illustrates an example compass user interface element 300, according to an implementation. As described in more detail below, the compass user interface element 300 can be associated with a particular layer that has been added to a mapping user interface. The compass user interface element 300 includes a name label 302 indicating the added layer (e.g., hospitals in this example). A distance label 304 indicates the distance to the closest element of the added layer (e.g., 12.5 km), from the position of the compass user interface element 300. A pointer 306 indicates the direction to the closest element of the added layer (e.g., the pointer 306 “points to” the closest element).

The user can select a close control 308 to close the compass user interface element 300. A zoom-out control 310 can be selected to zoom the displayed map segment so that all elements included in the added layer are visible on the map segment. For example, when the layer is initially added to the mapping user interface, some or all of the elements may be off-screen. The user can select the zoom-out control 310 to quickly see all elements of the added layer. A zoom-in control 312 can be selected to zoom the displayed map segment to display, on the map segment, the element included in the added layer that is closest to the compass user interface element 300.

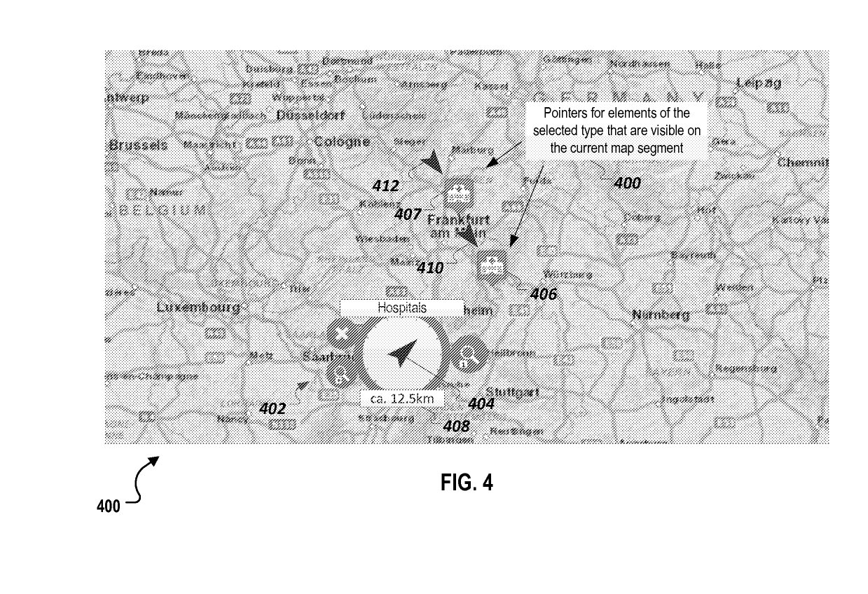

FIG. 4 illustrates an example compass user interface element 402 displayed on an example map segment 400, according to an implementation. The example map segment 400 displays multiple layers, including cities and roads. The user has initiated an action to add a hospital layer to the map segment 400. In response to adding the hospital layer to the map segment 400, the compass user interface 402 can be added to the map segment 400. For example, the user may have initiated the adding of the hospital layer and the compass user interface element 402 to the map segment 400 by performing a “drag and drop” operation ending in the dropping of a dragged user interface indicator on the map segment 400 at the displayed position of the compass user interface element 402.

The compass user interface element 402 includes a pointer 404 which points to a closest hospital element 406 in the hospital layer which is closest to the compass user interface element 402. The pointer 404 thus indicates the direction of the closest hospital element 406. The closest hospital element 406 is closer to the compass user element 402 than a second hospital element 407, for example. A label 408 on the compass user interface element 402 indicates that the closest hospital element 406 is 12.5 km from the compass user interface element 402.

In some implementations, data pointers are displayed on the elements included in the selected layer. For example, a first pointer 410 is displayed adjacent to the closest hospital element 406. A second pointer 412 is displayed adjacent to the second hospital element 407. Data pointers can be displayed, for example, to emphasize that the corresponding elements belong to the selected layer.

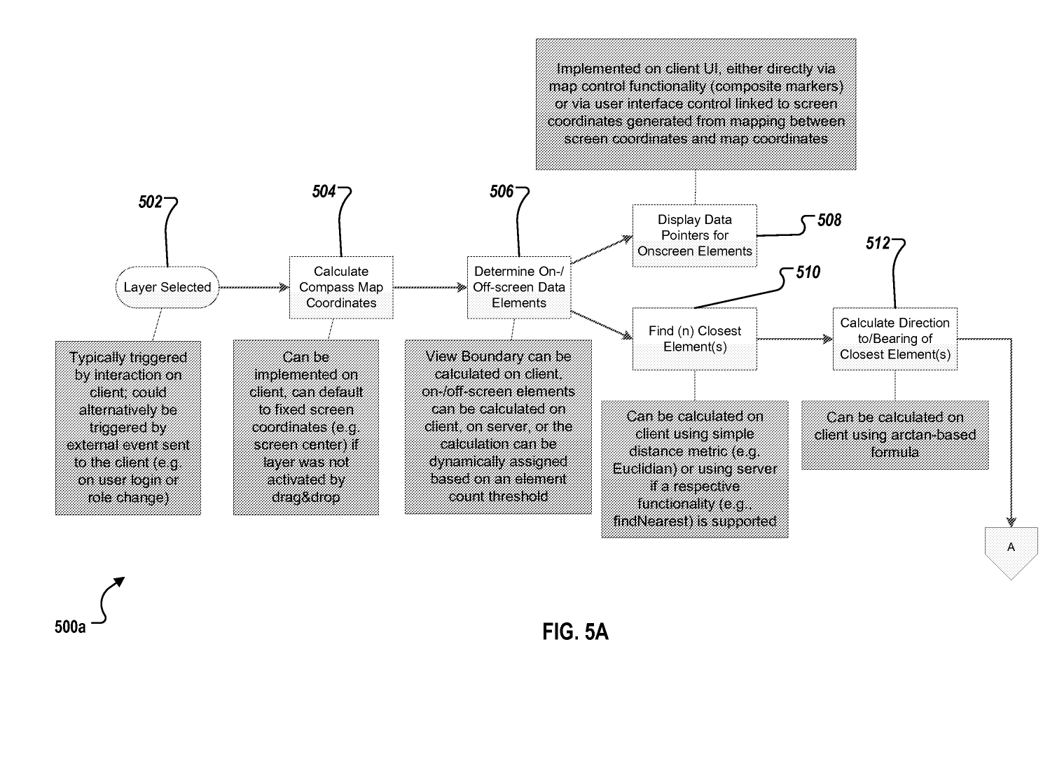

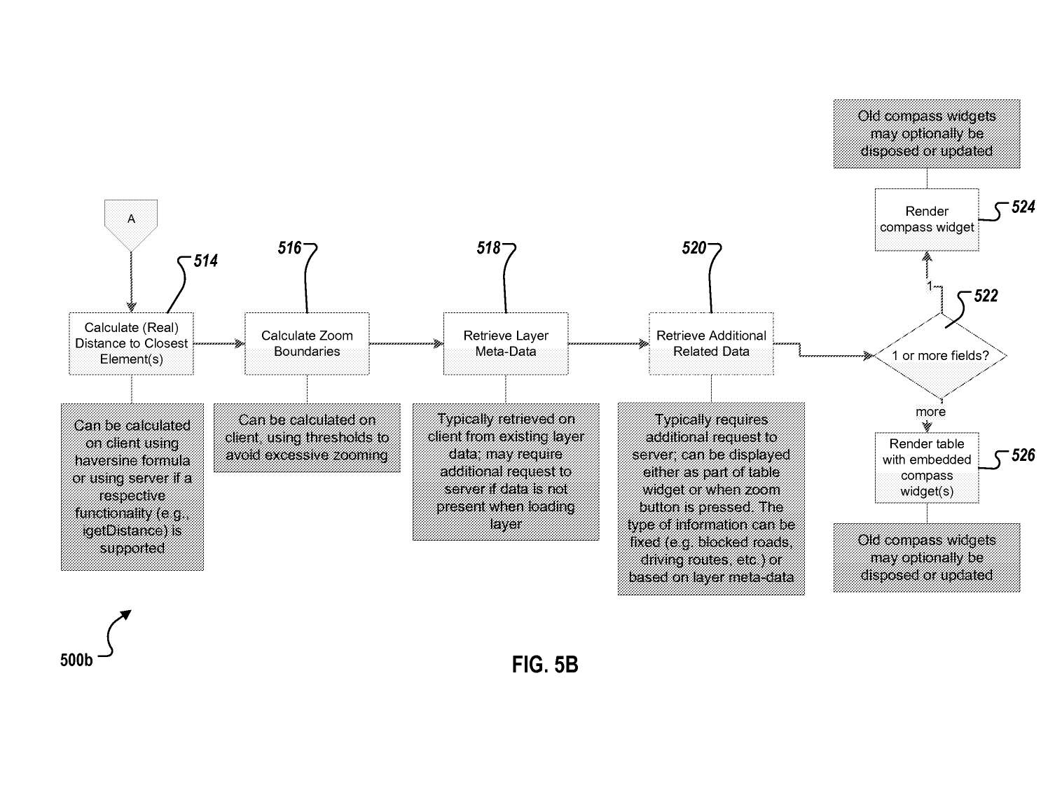

FIGS. 5A and 5B are flow charts of an example method 500 (represented by methods 500a and 500b, respectively) for improving user orientation when working with spatial data on a mapping interface, according to an implementation. For clarity of presentation, the description that follows generally describes method 500 in the context of FIGS. 1-4 and 6-7. However, it will be understood that method 500 may be performed, for example, by any other suitable system, environment, software, and hardware, or a combination of systems, environments, software, and hardware as appropriate. In some implementations, various steps of method 500 can be run in parallel, in combination, in loops, and/or in any order.

Turning to FIG. 5A, at 502, a layer to add to a mapping user interface is selected. For example, the adding of the selected layer can be initiated on the client device 102. For example, a user having a particular role may select a layer type user interface element representing a layer type available to the user and “drag and drop” the layer type user interface element onto a particular position on a displayed map segment. Although reference is made to a layer, another type of data structure that includes information for a collection of elements can be selected.

As another example, the adding of the selected layer can be triggered by an external event sent to the client device 102. For example, the client 102 may receive a notification that a user has logged in to the server 104. The mapping application 106 may be configured, for example, to automatically create and add a layer for the user upon user login, with the added layer being selected based on a defined role of the user.

At 504, a set of screen coordinates on the mapping user interface are calculated for a compass user interface element. The compass user interface element is associated with the selected layer. The screen coordinates can correspond to a location on the mapping user interface at which a layer type user interface element was dropped. If the layer is added automatically or otherwise without user interaction with the mapping user interface, the screen coordinates of the compass user interface element can be defaulted to predefined values, such as the center of the displayed mapping user interface.

Map coordinates that are equivalent to the set of screen coordinates can be calculated for the compass user interface element. The map coordinates can be internal coordinates used by the server 104 which are a different set of coordinates than the screen coordinates. The screen coordinates can be pixel coordinates, for example, corresponding, for example, to a 1000×800 screen display area. The map coordinates can correspond to a physical geographic location.

At 506, on- and off-screen data elements associated with the added layer are determined. A view boundary can be calculated, for example, on the client 102 or the server 104. The view boundary can include, for example, smallest and largest X and Y coordinates of the currently visible map segment. A set of elements associated with the selected layer can be identified. For each identified element, an X and Y coordinate of the element can be identified and compared to the smallest and largest X and Y coordinates of the currently visible map segment, to determine whether the element is on-screen or off-screen. On- and off-screen elements can be added to either a list of on-screen elements or a list of off-screen elements. For each on-screen element, both screen and map coordinates can be determined and associated with the respective on-screen element.

At 508, data pointers for on-screen elements are displayed. The displaying of on-screen elements can be performed in a new, different thread. For each on-screen element, an data pointer (e.g., the pointer 410) is generated and displayed on the map user interface. In some implementations, the data pointer and the element are combined to form a composite element. In some implementations, a separate pointer user interface element is created for each on-screen element and synchronized with the corresponding on-screen element.

At 510, a set of N closest data elements to the compass user interface element are located, for a predetermined N elements, where N can be, for example, one, or some other positive integer. The N closest elements can be determined, for example, on the client 102 using a Euclidean distance computation that computes the distance from a respective element to the compass user interface element, based on the map coordinates of the compass user interface element. As another example, the N closest elements can be determined on the server 104, using, for example, a built-in function, such as findNearest( ) or some other function.

At 512, a direction to the compass user interface element is determined for each of the set of N closest elements. A determined direction can be referred to as a bearing of a respective element. An arc-tangent function (e.g., a tan 2) can be used to determine the direction to an element. For example, given the x and y position of an element, a radian value r corresponding to the direction of the element can be computed using the following formula:

r=180/π×a tan 2(x,y).

The value r in radians can be converted to an equivalent degree value.

Turning now to FIG. 5B, at 514, a distance from the compass user interface element to each of the set of N closest elements is determined. The distance calculations can be performed in a separate, asynchronous thread. The distances can be calculated on the client 102, for example, using the Haversine formula, e.g.

$$d = 2 r ( {sin}^{2} ( \frac{( {φ}_{2} - {φ}_{1} )}{2} ) + cos ( {φ}_{1} ) cos ( {φ}_{2} ) {sin}^{2} ( \frac{( {λ}_{2} - {λ}_{1} )}{2} )$$

with r the diameter of the Earth, and φ and λ the latitude and longitude of the respective elements, and/or other formulas that allow calculation of distances between projected map coordinates. As another example, the distances can be calculated on the server 104, using, for example, a built in function such as getDistance( ) or some other function incorporating various distance calculating formulas.

At 516, one or more zooming boundaries associated with the mapping user interface are determined. For example, a zoom-out boundary associated with the zoom-out control 310 can be determined. As another example, a zoom-in boundary associated with the zoom-in control 312 can be determined. The zoom-out boundary can correspond to a map segment that includes each element in the selected layer. In some implementations, the zoomed-out map segment can be constrained by a zoom-out threshold. If the zoom-out threshold is reached, some, but not all of the elements in the selected layer may be included in the zoomed-out map segment. The zoom-in boundary can correspond to a map segment that includes the N closest elements. The zoom-in boundary can include a buffer surrounding the N closest elements. For example, the buffer can be a distance of two miles which can ensure that each of the closest N elements is displayed at most two miles from a map border.

At 518, meta-data associated with the selected layer is retrieved. For example, a layer name associated with the selected layer can be obtained. The layer name can be retrieved from the server 104, for example. As another example, the layer name or other meta-data may be obtained by the client 102.

At 520, additional data related to the selected layer is optionally retrieved. For example, one or more data fields may be associated with each element. Data fields can include costs, descriptive fields (e.g., resource name), or other data fields.

At 522, a determination is made as to whether the additional data includes more than a threshold number (e.g., one) of fields. For example, a determination can be made as to whether to display the additional data in a table representation. When multiple fields of additional data are obtained, the additional data can be presented in a table representation. When no additional data fields (or, in some implementations, less than the threshold number of additional data fields) have been obtained, a table representation is not used.

For example, when the additional data does not include more than the threshold number of fields, the compass user interface element is rendered, at 524, without using a table representation. The rendered compass user interface element can include the obtained layer name (e.g., in the name label 302) and the distance to the closest element (e.g., in the distance label 304). In some implementations, when additional data having less than the threshold number of fields has been obtained, the additional data is displayed within the compass user interface element (e.g., in the name label 302, the distance label 304, or in some other label). For example, the additional data may include one field, and the field value for the one field can be concatenated with the layer name or the distance value, and displayed in the name label 302, or the distance label 304, respectively.

When on-screen elements have been determined, the on-screen elements (and associated data pointers) can be rendered. In some implementations, the additional data is displayed in association with the on-screen elements. For example, when the additional data includes one field, the field value for each element can be displayed adjacent to the data pointer for the element.

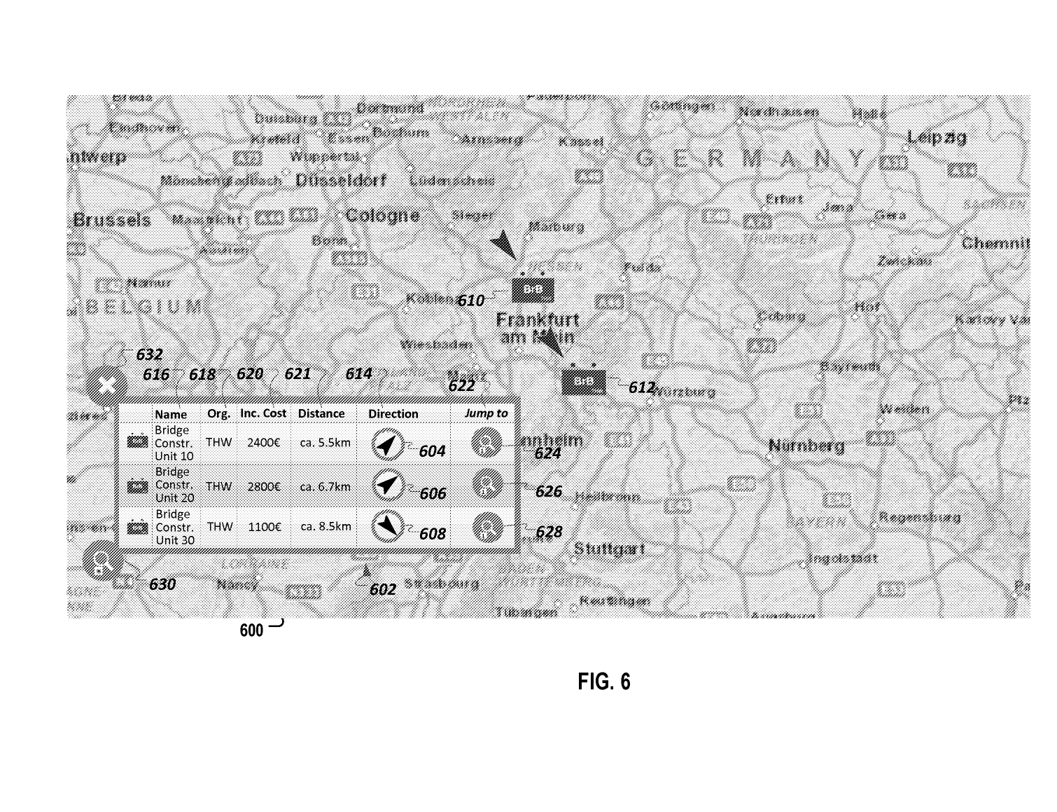

When more than the threshold number of fields are included in the additional data, a table is rendered with the compass user interface element rendered within the table (e.g., see FIG. 6), at 526. The table can be used, for example, to display values for the additional data fields.

FIG. 6 illustrates an example table 602 with embedded compass user interface elements 604, 606, and 608, rendered on a mapping user interface 600, according to an implementation. The selected layer in this example displays information about bridge construction. The compass user interface elements 604 and 606 point at first and second on-screen bridge construction elements 610 and 612, respectively. The compass user interface element 608 points at an off-screen bridge construction element. The table 602 can include a row for each of the closest N elements identified in the process 500, for example.

The compass user interface elements 604, 606, and 608 are included in a direction column 614 of the table 602. The table 602 also includes a name column 616, an origin column 618, an incremental cost column 620, a distance column 621, and a jump-to column 622. The name column 616, the origin column 618, and the incremental cost column 620 display values for the additional data fields retrieved for the elements corresponding to the respective rows of the table 602. In some implementations, the distance column 621 displays, for each of the compass user interface elements 604, 606, and 608, a respective distance between a reference point of the table 602 and the element associated with the respective compass user interface element. The reference point can be, for example, the center of the table 602 or a particular corner of the table 602. As another example, the distance column 621 can display, for each of the compass user interface elements 604, 606, and 608, a distance between the respective compass user interface element and the associated element pointed to by the respective compass user interface element.

The jump-to column 622 includes zoom-controls 624, 626, and 628 which can be used to zoom-in to the first on-screen bridge construction element 610, the second on-screen bridge construction element 612, and the off-screen bridge construction element associated with the compass user interface element 608, respectively. A zoom-out control 630 can be selected to zoom the mapping user interface 600 to include each of the elements in the selected layer, for example. As another example, the zoom-out control 630 may zoom the mapping user interface 600 so that each of the N closest elements are displayed. The user can select a close control to close the table 602.

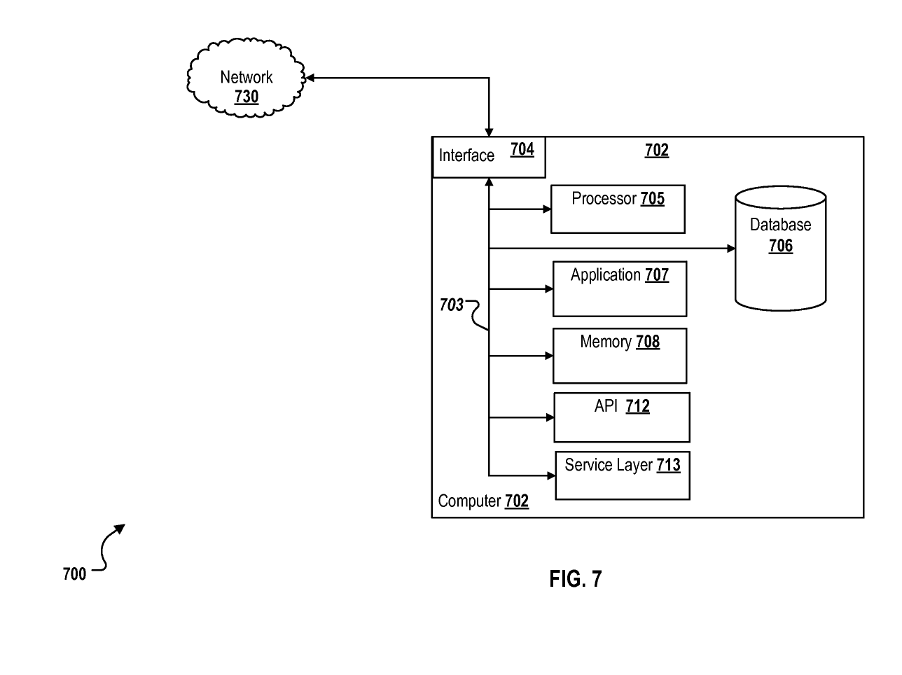

FIG. 7 is a block diagram 700 of an exemplary computer 702 used in the EDCS 100, according to an implementation. The illustrated computer 702 is intended to encompass any computing device such as a server, desktop computer, laptop/notebook computer, wireless data port, smart phone, personal data assistant (PDA), tablet computing device, one or more processors within these devices, or any other suitable processing device, including both physical and/or virtual instances of the computing device. Additionally, the computer 702 may comprise a computer that includes an input device, such as a keypad, keyboard, touch screen, or other device that can accept user information, and an output device that conveys information associated with the operation of the computer 702, including digital data, visual and/or audio information, or a GUI.

The computer 702 can process for/serve as a client (e.g., client 102 or one or more subcomponents), a server (e.g., server 104 or one or more subcomponents), and/or any other component of the EDCS 100 (whether or not illustrated). The illustrated computer 702 is communicably coupled with a network 730. In some implementations, one or more components of the computer 702 may be configured to operate within a cloud-computing-based environment.

At a high level, the computer 702 is an electronic computing device operable to receive, transmit, process, store, or manage data and information associated with the EDCS 100. According to some implementations, the computer 702 may also include or be communicably coupled with a cloud-computing server, application server, e-mail server, web server, caching server, streaming data server, business intelligence (BI) server, and/or other server.

The computer 702 can generate requests to transmit over network 730 (e.g., as a client 102) or receive requests over network 730 from a client application (e.g., the mapping application 106) and responding to the received requests by processing the said requests in an appropriate software application, hardware, etc. In addition, requests may also be sent to the computer 702 from internal users (e.g., from a command console or by other appropriate access method), external or third-parties, other automated applications, as well as any other appropriate entities, individuals, systems, or computers.

Each of the components of the computer 702 can communicate using a system bus 703. In some implementations, any and/or all the components of the computer 702, both hardware and/or software, may interface with each other and/or the interface 704 over the system bus 703 using an API 712 and/or a service layer 713. The API 712 may include specifications for routines, data structures, and object classes. The API 712 may be either computer-language independent or dependent and refer to a complete interface, a single function, or even a set of APIs. The service layer 713 provides software services to the computer 702 and/or the EDCS 100. The functionality of the computer 702 may be accessible for all service consumers using this service layer. Software services, such as those provided by the service layer 713, provide reusable, defined business functionalities through a defined interface. For example, the interface may be software written in JAVA, C++, or other suitable language providing data in extensible markup language (XML) format or other suitable format. While illustrated as an integrated component of the computer 702, alternative implementations may illustrate the API 712 and/or the service layer 713 as stand-alone components in relation to other components of the computer 702 and/or EDCS 100. Moreover, any or all parts of the API 712 and/or the service layer 713 may be implemented as child or sub-modules of another software module, enterprise application, or hardware module without departing from the scope of this disclosure.

The computer 702 includes an interface 704. Although illustrated as a single interface 704 in FIG. 7, two or more interfaces 704 may be used according to particular needs, desires, or particular implementations of the computer 702 and/or EDCS 100. The interface 704 is used by the computer 702 for communicating with other systems in a distributed environment—including within the EDCS 100—connected to the network 730 (whether illustrated or not). Generally, the interface 704 comprises logic encoded in software and/or hardware in a suitable combination and operable to communicate with the network 730. More specifically, the interface 704 may comprise software supporting one or more communication protocols associated with communications such that the network 730 or interface's hardware is operable to communicate physical signals within and outside of the illustrated EDCS 100.

The computer 702 includes a processor 705. Although illustrated as a single processor 705 in FIG. 7, two or more processors may be used according to particular needs, desires, or particular implementations of the computer 702 and/or the EDCS 100. Generally, the processor 705 executes instructions and manipulates data to perform the operations of the computer 702. Specifically, the processor 705 executes the functionality required for improving user orientation when working with spatial data on a mapping interface.

The computer 702 also includes a database 706 and memory 708 that hold data for the computer 702 and/or other components of the EDCS 100. Although illustrated as a single database 706 and memory 708 in FIG. 7, two or more databases 708 and memories 708 may be used according to particular needs, desires, or particular implementations of the computer 702 and/or the EDCS 100. While database 708 and memory 708 are illustrated as integral components of the computer 702, in alternative implementations, the database 706 and memory 708 can be external to the computer 702 and/or the EDCS 100. In some implementations, the database can be a conventional database or an in-memory database, or a mix of both. In some implementations, the database 706 and memory 708 can be combined into one component.

The application 707 is an algorithmic software engine providing functionality according to particular needs, desires, or particular implementations of the computer 702 and/or the EDCS 100, particularly with respect to functionalities required for improving user orientation when working with spatial data on a mapping interface. For example, application 707 can serve as the mapping application 106, and/or any other component of the EDCS 100 (whether or not illustrated). Further, although illustrated as a single application 707, the application 707 may be implemented as multiple applications 707 on the computer 702. In addition, although illustrated as integral to the computer 702, in alternative implementations, the application 707 can be external to the computer 702 and/or the EDCS 100.

There may be any number of computers 702 associated with, or external to, the EDCS 100 and communicating over network 730. Further, the term “client,” “user,” and other appropriate terminology may be used interchangeably as appropriate without departing from the scope of this disclosure. Moreover, this disclosure contemplates that many users may use one computer 702, or that one user may use multiple computers 702.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible, non-transitory computer-storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of one or more of them.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, e.g., a central processing unit (CPU), an FPGA (field programmable gate array), or an ASIC (application-specific integrated circuit). In some implementations, the data processing apparatus and/or special purpose logic circuitry may be hardware-based and/or software-based. The apparatus can optionally include code that creates an execution environment for computer programs, e.g., code that constitutes processor firmware, a protocol stack, a database management system, an operating system, or a combination of one or more of them. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a global positioning system (GPS) receiver, or a portable storage device, e.g., a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, e.g., erasable programmable read-only memory (EPROM), electrically erasable programmable read-only memory (EEPROM), and flash memory devices; magnetic disks, e.g., internal hard disks or removable disks; magneto-optical disks; and CD-ROM, DVD+/−R, DVD-RAM, and DVD-ROM disks. The memory may store various objects or data, including caches, classes, frameworks, applications, backup data, jobs, web pages, web page templates, database tables, repositories storing business and/or dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), LED (Light Emitting Diode), or plasma monitor, for displaying information to the user and a keyboard and a pointing device, e.g., a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The term “graphical user interface,” or “GUI,” may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of wireline and/or wireless digital data communication, e.g., a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n and/or 802.20, all or a portion of the Internet, and/or any other communication system or systems at one or more locations. The network may communicate with, for example, Internet Protocol (IP) packets, Frame Relay frames, Asynchronous Transfer Mode (ATM) cells, voice, video, data, and/or other suitable information between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware and/or software, may interface with each other and/or the interface using an application programming interface (API) and/or a service layer. The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers via this service layer. Software services provide reusable, defined business functionalities through a defined interface. For example, the interface may be software written in JAVA, C++, or other suitable language providing data in extensible markup language (XML) format or other suitable format. The API and/or service layer may be an integral and/or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking and/or parallel processing may be advantageous and performed as deemed appropriate.

Moreover, the separation and/or integration of various system modules and components in the implementations described above should not be understood as requiring such separation and/or integration in all implementations, and it should be understood that the described program components and systems can generally be integrated together in a single software product or packaged into multiple software products.

Accordingly, the above description of example implementations does not define or constrain this disclosure. Other changes, substitutions, and alterations are also possible without departing from the spirit and scope of this disclosure.

What is claimed is:

1. A computer-implemented method, comprising:
calculating a set of screen coordinates on a mapping user interface for a compass user interface element, the compass user interface element associated with a layer selected to add to the mapping user interface;
calculating map coordinates equivalent to the set of screen coordinates for the compass user interface element;
determining on- and off-screen data elements associated with the added layer;
calculating direction and distance to a closest number of data elements from the map coordinates of the compass user interface element; and
rendering the compass user interface element on the mapping user interface.

2. The method of claim 1, wherein the determination is made based on the smallest and largest X and Y coordinates of a visible segment of the mapping user interface.

3. The method of claim 1, wherein the calculation of direction and distance to the closest number of data elements is performed in the same processing loop where the on- and off-screen data elements are determined.

4. The method of claim 1, comprising displaying data pointers for on-screen data elements.

5. The method of claim 1, comprising calculating a zooming boundary associated with the mapping user interface.

6. The method of claim 1, comprising:
retrieving meta-data associated with the selected layer; and
retrieving additional related data associated with the selected layer for display on the mapping user interface.

7. The method of claim 1, comprising rendering a table with embedded compass widgets if the closet number of data elements exceeds one.

8. A non-transitory, computer-readable medium storing computer-readable instructions, the instructions executable by a computer and configured to:
calculate a set of screen coordinates on a mapping user interface for a compass user interface element, the compass user interface element associated with a layer selected to add to the mapping user interface;
calculate map coordinates equivalent to the set of screen coordinates for the compass user interface element;
determine on- and off-screen data elements associated with the added layer;
calculate direction and distance to a closest number of data elements from the map coordinates of the compass user interface element; and
render the compass user interface element on the mapping user interface.

9. The medium of claim 8, wherein the determination is made based on the smallest and largest X and Y coordinates of a visible segment of the mapping user interface.

10. The medium of claim 8, wherein the calculation of direction and distance to the closest number of data elements is performed in the same processing loop where the on- and off-screen data elements are determined.

11. The medium of claim 8, configured to display data pointers for on-screen data elements.

12. The medium of claim 8, configured to calculate a zooming boundary associated with the mapping user interface.

13. The medium of claim 8, configured to:
retrieve meta-data associated with the selected layer; and
retrieve additional related data associated with the selected layer for display on the mapping user interface.

14. The medium of claim 8, configured to render a table with embedded compass widgets if the closet number of data elements exceeds one.

15. A system, comprising:
a memory;
at least one hardware processor interoperably coupled with the memory and configured to:
calculate a set of screen coordinates on a mapping user interface for a compass user interface element, the compass user interface element associated with a layer selected to add to the mapping user interface;
calculate map coordinates equivalent to the set of screen coordinates for the compass user interface element;
determine on- and off-screen data elements associated with the added layer;
calculate direction and distance to a closest number of data elements from the map coordinates of the compass user interface element; and
render the compass user interface element on the mapping user interface.

16. The system of claim 15, wherein the calculation of direction and distance to the closest number of data elements is performed in the same processing loop where the on- and off-screen data elements are determined.

17. The system of claim 15, configured to display data pointers for on-screen data elements.

18. The system of claim 15, configured to calculate a zooming boundary associated with the mapping user interface.

19. The system of claim 15, configured to:
retrieve meta-data associated with the selected layer; and
retrieve additional related data associated with the selected layer for display on the mapping user interface.

20. The system of claim 15, configured to render a table with embedded compass widgets if the closet number of data elements exceeds one.
